(19) United States
(12) Patent Application Publication
(10) Pub. No.: US 2026/0094182 A1
(43) Pub. Date: Apr. 2, 2026

(54) CONTENT PROMOTION SYSTEM

(71) Applicant: Tubi, Inc., San Francisco, CA (US)

(72) Inventors: Sandeep Gupta, Santa Clara, CA (US); Jaya Kawale, San Jose, CA (US); Chiyu Zhong, Bellevue, WA (US); John Trenkle, Albany, CA (US); Marios Assiotis, Park City, UT (US)

(73) Assignee: Tubi, Inc., San Francisco, CA (US)

(21) Appl. No.: 18/900,513

(22) Filed: Sep. 27, 2024

(51) Int. Cl. G06Q 30/0241; G06Q 30/0242

(52) U.S. Cl. CPC G06Q 30/0249; G06Q 30/0245

(57) ABSTRACT

A system and method for promoting content items in a content platform, including: a computer processor, a content promoter service executing on the computer processor and including functionality to identify an impression budget and a pacing parameter for impressions of an unvetted content item and utilize the impression budget and the pacing parameter to control availability of the unvetted content item for artificial promotion, a content recommender service including functionality to receive a request for content for a container, identify a set of vetted content items based on historical performance, artificially promote the unvetted content item by injecting it into the set of vetted content items and providing the final set of content in response to the request, and a content cold-start service configured to select the unvetted content item as a candidate for injection based on similarity to a surrogate content item in the set of vetted content items.

### BACKGROUND

The proliferation of content across various platforms has presented significant challenges and opportunities for content providers and distributors. As the volume of available content has grown exponentially, so too has the complexity of effectively promoting and recommending content to users in a way that maximizes engagement and satisfaction. The development and application of advanced algorithms and machine learning techniques have become integral to addressing these challenges.

Historically, content recommendation systems have relied heavily on the collection and analysis of user data to suggest content based on individual preferences and viewing habits. These systems aim to predict what content a user is most likely to enjoy, thereby increasing user engagement and retention. However, the challenge of effective search, relevance, recommendation, discovery, and content promotion continues to grow as the volume and variety of content increases with time. One recurring challenge in these systems is the “cold start” problem, which occurs when there is insufficient historical data about new content items to make accurate recommendations.

In recent years, there has been a growing interest in leveraging artificial intelligence and machine learning to enhance various aspects of content recommendation and promotion. These technologies offer the potential to analyze vast amounts of data, identify patterns, and make data-driven decisions that can improve user experiences on content platforms.

The evolution of content promotion and recommendation systems continues to be a critical area of research and development, driven by the need to optimize the delivery of relevant content to users.

### SUMMARY

In general, in one aspect, embodiments relate to systems and methods for promoting content items in a content platform. This can include unvetted content items which have not accumulated a threshold amount of live performance data and/or those for which performance data is not known to the system at the time when content is requested. The unvetted content item is ingested and associated data is identified which can then be utilized to configure the content for promotion. The promotion of content items can involve pacing and budget parameters which determine availability and other parameters which control the artificial injection of the unvetted content in response to content requests. This functionality can be used in conjunction with a cold-start system configured to identify said available unvetted items for injection based on various factors including similarity to one or more surrogate content items.

In general, in one aspect, embodiments relate to a system for promoting content items in a content platform. The system can include a computer processor, a content promoter service executing on the computer processor and including functionality to identify an impression budget and a pacing parameter for impressions of an unvetted content item and utilize the impression budget and the pacing parameter to control availability of the unvetted content item for artificial promotion, a content recommender service including functionality to receive a request for content for a container, identify a set of vetted content items based on historical performance, artificially promote the unvetted content item by injecting it into the set of vetted content items and providing the final set of content in response to the request, and a content cold-start service configured to select the unvetted content item as a candidate for injection based on similarity to a surrogate content item in the set of vetted content items.

In general, in one aspect, embodiments relate to a method for promoting content items in a content platform. The method can include (i) receiving a request for content for a container, (ii) identifying a set of vetted content items based on historical performance of the set of vetted content items, (iii) identifying an impression budget and a pacing parameter for impressions of an unvetted content item, (iv) utilizing, by a computer processor, the impression budget and the pacing parameter to control availability of an unvetted content item for artificial promotion, (v) selecting the unvetted content item based on similarity to a surrogate content item in the set of vetted content items and (vi) artificially promoting the unvetted content item by injecting it into the set of vetted content items and providing the set of vetted content items including the injected unvetted content item in response to the request.

In general, in one aspect, embodiments relate to a non-transitory computer-readable storage medium having instructions for promoting content items in a content platform. The instructions are configured to execute on at least one computer processor to enable the computer processor to (i) receive a request for content for a container, (ii) identify a set of vetted content items based on historical performance of the set of vetted content items, (iii) identify an impression budget and a pacing parameter for impressions of an unvetted content item, (iv) utilize the impression budget and the pacing parameter to control availability of an unvetted content item for artificial promotion, (v) select the unvetted content item based on similarity to a surrogate content item in the set of vetted content items and (vi) artificially promote the unvetted content item by injecting it into the set of vetted content items and providing the set of vetted content items including the injected unvetted content item in response to the request.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIGS. 1A-1C show schematic diagrams of a content platform, in accordance with one or more embodiments.

FIG. 2 shows an interaction diagram between various components of the content platform, in accordance with one or more embodiments.

FIG. 3 shows a state diagram for content items of the content platform, in accordance with one or more embodiments.

FIGS. 4-5 show flowcharts depicting promotion of content items in a content platform, in accordance with one or more embodiments.

FIG. 6 shows a flowchart depicting execution of a machine learning model for inference of content promotion parameters of an unvetted content item, in accordance with one or more embodiments.

FIG. 7 shows a flowchart depicting training and deployment of a supervised machine learning model, in accordance with one or more embodiments.

FIGS. 8 and 9 show a computing system and network architecture in accordance with one or more embodiments.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

In general, embodiments of the present disclosure provide methods and systems for promotion, recommendation, and discovery of media items. One or more content items are selected for artificial injection into a container based on similarity to a surrogate content item. A variety of different mechanisms are described for selection of content for promotion, including optional integration with a cold-start system. Promotional and/or unvetted content item promotion is controlled using a variety of parameters such as pacing thresholds and budgeting quotas or formulas.

The systems and methods disclosed in the present disclosure include functionality relating to media promotion/recommendation and related functionality using various types of media items. For exemplary purposes, though many of the foregoing systems and processes are described in the context of a streaming advertisement media item, they can be performed on a variety of different media types and formats, including audio-only (music/speech/nature/scientific), television shows, video games, social media posts, advertisements, and any other media content served to one or more audiences for which it may be desirable to improve or optimize the delivery of relevant content.

In one or more embodiments of the invention, the promoted content items are unvetted content items for which insufficient performance data exists to perform organic recommendation. In other scenarios, the promoted content items may include vetted or partially vetted content, often referred to as warm-start content, and/or a mixture of vetted and unvetted content. While many descriptions of the systems and methods in this disclosure are specific to unvetted content types, this should not be construed as limiting the scope of the invention. The systems and methods are applicable to a range of content types, allowing for flexibility in content promotion strategies and ensuring a broad applicability of the disclosed technologies.

In one or more embodiments of the invention, the system can be utilized for a variety of applications and content types beyond media content, including e-commerce, physical products, merchandise, or any other domain that requires a cold-start mechanism. The system leverages a well-known inventory to effectively cold-start new content in these diverse applications. For instance, in e-commerce, the system can promote new products by associating them with popular, well-established items to enhance visibility and user engagement. Similarly, in merchandising, the system can introduce new merchandise by linking it to best-selling items. While aspects of the description are specific to media content, this should not be construed as limiting the scope of the invention, as the underlying principles and methods are broadly applicable across various fields requiring cold-start solutions.

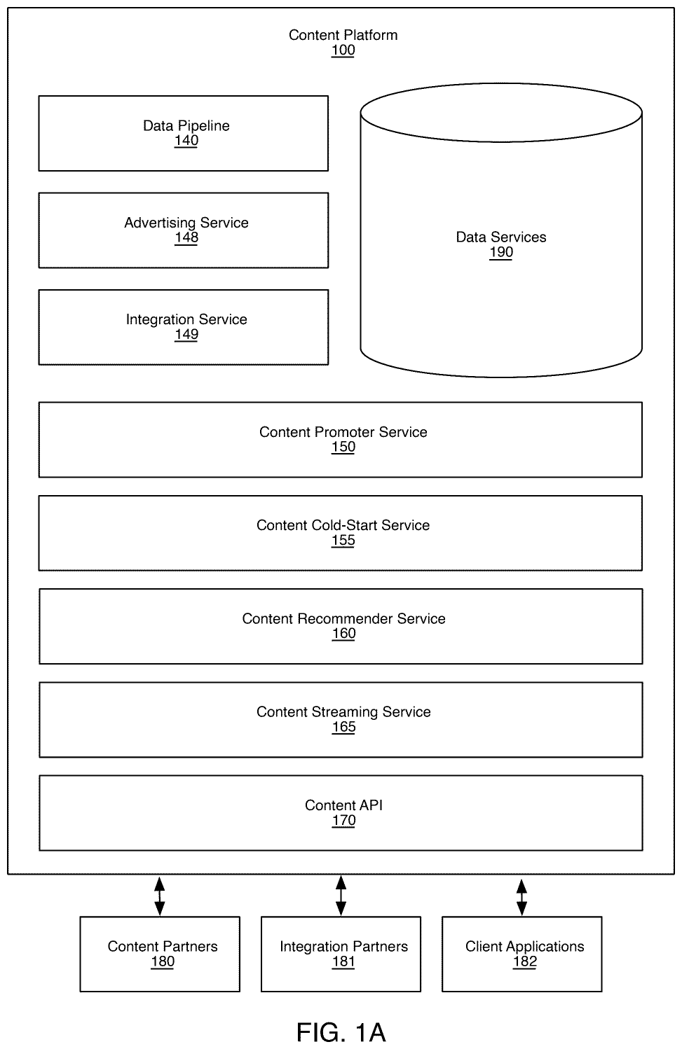

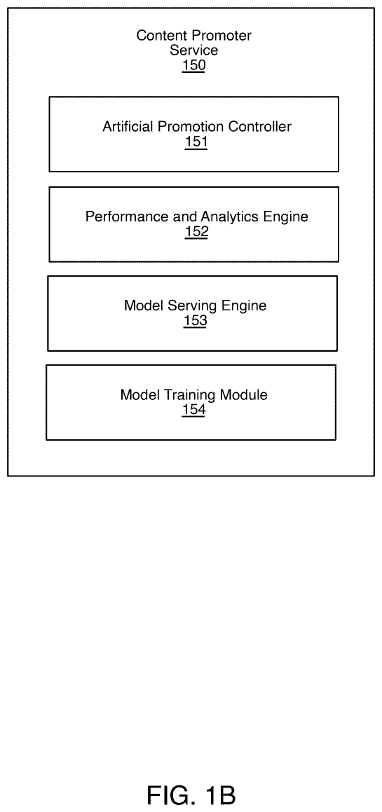

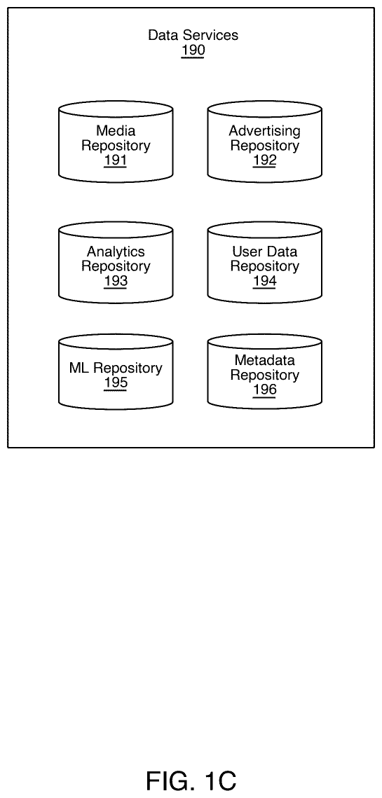

FIG. 1A shows a content platform 100, content partners 180, integration partners 181, and client applications 182, in accordance with one or more embodiments. As shown in FIG. 1A, the content platform 100 has multiple components including a data pipeline 140, an advertising service 148, an integration service 149, data services 190, a content promoter service 150, a content cold-start service 155, a content recommender service 160, a content streaming service 165, a content application programming interface (API) 170. Various components of the content platform 100 can be located on the same device (e.g., a server, mainframe, a virtual compute resource residing in a virtual private cloud (VPC), a desktop Personal Computer (PC), laptop, mobile device, and any other device) or can be located on separate devices connected by a network (e.g., a local area network (LAN), wide area network (WAN), the Internet, etc.). Those skilled in the art will appreciate that there can be more than one of each separate component running on a device, as well as any combination of these components within a given embodiment.

The arrangement of the components and their corresponding architectural design are depicted as being distinct and separate for illustrative purposes only. Many of these components can be implemented within the same binary executable, containerized application, virtual machine, pod, or container orchestration cluster. Performance, cost, and application constraints can dictate modifications to the architecture without compromising function of the depicted systems and processes.

In one or more embodiments, the content platform 100 is a platform for facilitating analysis, streaming, serving, and/or generation of media-related content. For example, the content platform 100 may store or be operatively connected to services storing millions of media items such as movies, user-generated videos, music, audio books, and any other type of media content. The media content may be provided for viewing by end users of a video or audio streaming service (e.g., content streaming service 165), for example. Media services provided by the content platform 100 can include, but are not limited to, advertising media services, content streaming, preview or user-generated content generation and streaming, and other functionality disclosed herein.

In one or more embodiments of the invention, the content platform 100 is a technology platform including multiple software services executing on different novel combinations of commodity and/or specialized hardware devices. The components of the content platform 100, in the non-limiting example of FIG. 1A, are software services implemented as containerized applications executing in a cloud environment. The data pipeline 140 and content promoter service 150 and related components can be implemented using specialized hardware to enable parallelized analysis and performance. Other architectures can be utilized in accordance with the described embodiments.

In one or more embodiments of the invention, the data pipeline 140, the advertising service 148, the integration service 149, the content promoter service 150, the content cold-start service 155, the content recommender service 160, the content streaming service 165, and the content application programming interface (API) 170 are software services or collections of software services configured to communicate both internally and externally of the content platform 100, to implement one or more of the functionalities described herein.

The systems described in the present disclosure may depict communication and the exchange of information between components using directional and bidirectional lines. Neither is intended to convey exclusive directionality (or lack thereof), and in some cases components are configured to communicate despite having no such depiction in the corresponding figures. Thus, the depiction of these components is intended to be exemplary and non-limiting. For example, one or more of the components of the content platform 100 may be communicatively coupled via a distributed computing system, a cloud computing system, or a networked computer system communicating via the Internet.

In one or more embodiments of the invention, the content streaming service 165 manages and/or delivers media content to end-user devices (e.g., by fetching media files from storage and dynamically, adjusting streaming quality based on network conditions, etc.). For example, a user selecting a video may trigger the service 165 to retrieve the video from the media repository 191 and stream it in the highest quality available, adjusting as needed to maintain smooth playback. This service can be incorporated into various systems, such as online streaming platforms, to enhance media delivery and user experience.

In one or more embodiments of the invention, the content API 170 provides programmable interfaces for external systems to interact with the content platform 100, enabling operations such as requesting content for one or more applications/containers, uploading media, querying metadata, and managing playback. For instance, a content provider or advertising network might use the API to upload a new video and its metadata, which the API then processes and stores in the media repository. The API facilitates integration with third-party applications, making it suitable for use in online streaming platforms and other content promotion/recommendation systems.

In one or more embodiments of the invention, the advertising service 148 manages the selection, insertion, and tracking of advertisements within media streams. By leveraging user data to target ads, dynamically placing them within content, and collecting performance metrics, the service ensures relevant and effective advertising. For example, a user watching a video might see targeted ads inserted at designated points, with the service tracking impressions and interactions. This component can be integrated into realtime bidding platforms or other applications requiring sophisticated ad management.

In one or more embodiments of the invention, the integration service 149 facilitates seamless interaction between the content platform 100 and external systems, supporting data ingestion, export, and real-time synchronization. For example, the service 149 can be configured to import media content and metadata from a third-party content management system.

### Content Promoter Overview

FIG. 1B shows the content promoter service 150, in accordance with one or more embodiments. As shown in FIG. 1B, the content promoter service 150 has multiple components including an artificial promotion controller 151, a performance and analytics engine 152, a model serving engine 153, and a model training module 154. Those skilled in the art will appreciate that there can be more than one of each separate component running on a device, as well as any combination of these components within a given embodiment.

In one or more embodiments of the invention, the content promoter service 150 enables artificial injection of promotional content items, particularly in the context of media streaming. These content items can include, but are not limited to, unvetted media content that lacks performance data sufficient for organic ranking and recommendation. The model serving engine 153 includes functionality to obtain a variety of metadata and data associated with the content item and to infer a set of promotional parameters controlling promotion of the content item by the service 150. The content platform 100 includes features for utilizing the inferred promotional parameters to selectively inject the content item into recommender results, in accordance with various embodiments of the invention.

In one or more embodiments of the invention, the content promoter service 150 is structured as a minimal advertising system, with the entry point being a campaign. Each campaign can have multiple content ads, each associated with parameters such as content ID, content type, policies, content ad units, language, tier, device impression cap, prominent device impression cap, impression cap, and pacing.

The policies associated with a content ad may include parameters like country, start time, and end time, ensuring that the content is shown in compliance with regional regulations and scheduling constraints. Content ad units define the containers in which the content ad will be promoted, such as specific user interface components.

In one or more embodiments of the invention, the content promoter service 150 promotes a content ad via a surrogate system, which places the content ad in proximity to similar content already in a recommendation matrix. The similarity is determined using machine learning models that generate a cold_start_similarity feature, calculating similarity scores between content ads and existing content (e.g., by content cold-start service 155).

In one or more embodiments of the invention, the system processes containers in parallel, retrieving user-specific languages and available content ads based on country and language preferences. It then identifies the top similar content for each container and checks various caps (campaign, content, and device) to determine if the content ad can be placed in the container.

### Data Pipeline

In one or more embodiments of the invention, the data pipeline 140 orchestrates the flow and processing of media content from ingestion to delivery. The data pipeline 140 encompasses multiple services, each responsible for specific aspects of media processing. These services can include a metadata extraction engine, a transcoding service, a packaging/delivery service, and a notification service (not shown).

In one or more embodiments of the invention, the metadata extraction engine is configured to extract metadata from media items. Metadata can include, but is not limited to, information such as title, description, duration, format, resolution, and codec details. The metadata extraction engine analyzes the media file headers and embedded metadata streams to gather this information.

In one or more embodiments of the invention, the transcoding service is responsible for converting media items into different formats and resolutions suitable for various delivery requirements. This service ensures that media content is available in the optimal format for playback on different devices and platforms.

In one or more embodiments of the invention, the packaging/delivery service prepares media content for distribution and manages the delivery process to end-users. This service ensures that media items are correctly packaged, including the creation of necessary streaming manifests and packaging formats.

In one or more embodiments of the invention, the notification service handles the generation and distribution of notifications related to media processing events. This service ensures that stakeholders are informed about the status of media items throughout the processing pipeline.

### Content Promoter Service

In one or more embodiments of the invention, the content promoter service 150 includes functionality to identify a range of promotion parameters for content items, often unvetted content items. These promotion parameters may include, but are not limited to, an impression budget, a pacing parameter, targeting demographics, geographic locations, and temporal parameters such as start and end dates for the promotion. These parameters can be entered by a human administrator based on various factors, including expected performance, marketing strategies, and target audience characteristics. For example, an administrator might set an impression budget of 10,000 views, a pacing parameter that limits the content to 1,000 views per hour, target demographics of ages 18-34, and geographic targeting limited to urban areas.

The content promoter service 150 utilizes the identified promotion parameters to control the availability of the content item for artificial promotion by a content cold-start service. This involves real-time monitoring and dynamic adjustment of the content's availability to adhere to the set budget, pacing, and other parameters. For example, if the pacing parameter is set to 1,000 impressions per hour, the service ensures that the content item is only available for promotion until this limit is reached, thereby preventing overexposure within any given time frame.

### Impression Capping

In one or more embodiments of the invention, the content promoter service 150 includes functionality to manage and enforce various types of impression caps for content ads. These caps are designed to control the frequency and visibility of content ads shown to users, ensuring a balanced and non-intrusive user experience while maximizing the effectiveness of promotional campaigns.

Impression Cap: The impression cap defines the total number of times a content ad will be displayed across all devices and users. This cap ensures that each ad campaign has a controlled and finite reach, allowing for better budget management and performance tracking. By setting an overall limit on impressions, the content promoter service 150 can effectively manage the distribution and lifespan of each promotional campaign, optimizing the exposure of new or unvetted content items while preventing oversaturation.

Device Impression Cap: The device impression cap specifies the maximum number of times a content ad can be displayed on a single device. This cap is intended to prevent overexposure of the same ad to individual users, thereby reducing ad fatigue and maintaining user engagement.

Prominent Device Impression Cap: The prominent device impression cap limits the number of times a content ad is shown in prominent containers, such as featured and “recommended-for-you” sections, before it is no longer displayed across all containers for a given user. This cap is particularly useful for high-visibility areas where excessive repetition of the same ad could detract from the user experience. The enforcement of this cap optionally includes a condition that considers an impression valid only if it was shown more than eight hours ago. When this condition is enabled, impressions shown within the last eight hours are not counted towards the cap.

In one or more embodiments of the invention, the performance and analytics engine 152 within the content promoter service 150 continuously monitors these caps, adjusting ad availability and distribution in real-time to adhere to the predefined limits. This dynamic adjustment helps in optimizing user engagement and ensuring that promotional efforts are both effective and user-friendly.

### Data Tiers

In one or more embodiments of the invention, the content promoter service 150 prioritizes content ads by tier, promoting lower-tier content ads before higher-tier ones. Tiers are determined based on the quality and expected performance of the content, with tier 0 being the highest priority.

In one or more embodiments of the invention, the content promoter service 150 tracks promotions using a promotional lever field in the content metadata, distinguishing between content ads promoted via automated systems and those promoted manually by administrators. This data is stored in the analytics repository 193, enabling detailed tracking and analysis.

In one or more embodiments of the invention, the content promoter service 150 supports at least two types of automated content ads: “shiny” titles and other new titles. Shiny titles may be configured to be promoted for a limited time with specific caps, while other new titles are promoted in genre-specific containers without impression caps.

### Promotion Algorithm

In one or more embodiments of the invention, the system utilizes a promotion algorithm designed to process content containers in parallel, efficiently promoting content ads based on predefined criteria. The algorithm ensures that each content ad is appropriately placed to maximize visibility and user engagement while adhering to various promotion parameters and similarity thresholds.

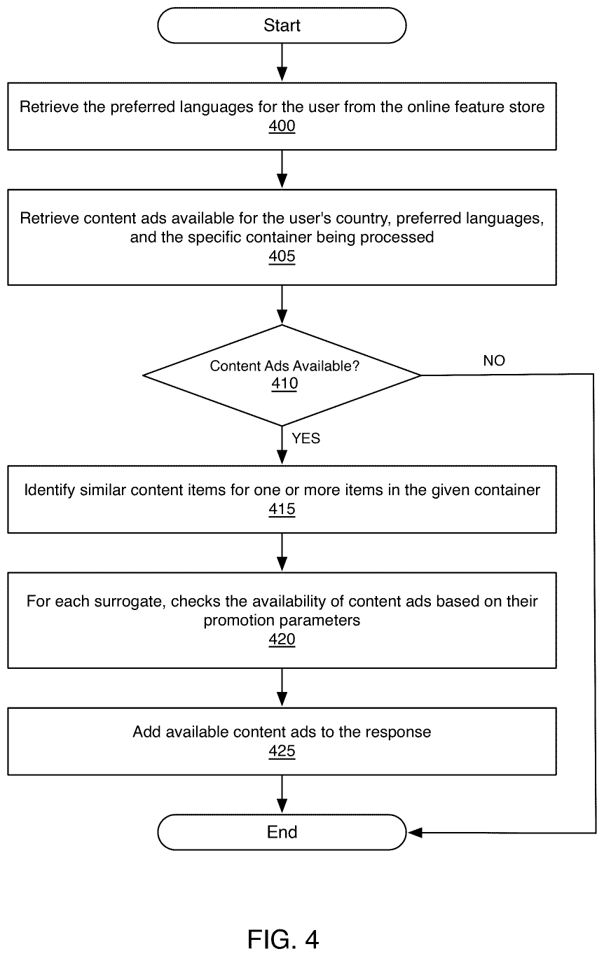

The promotion algorithm follows a series of steps, as illustrated in FIG. 4, which provides a detailed flowchart of the process:
STEP 400: The system retrieves the preferred languages for the user from the online feature store (OFS).
STEP 405: The system retrieves all content ads available for the user's country, preferred languages, and the specific container being processed.
STEP 410: If no content ads are available, the process stops for that container.
STEP 415: The system identifies similar content items for at least a subset of items in the container. For example, the first 20 titles may be examined for similarity.
STEP 420: For each surrogate (existing content in the container), the system checks the availability of content ads based on various caps (campaign, content, and device). It also ensures that the content ad is not already in the container and is not disliked by the user.
STEP 425: If the content ad meets all criteria, it is placed in the container.

For example, consider a scenario where the content promoter service 150 is processing a container for a user whose preferred languages are English and Spanish. The system retrieves all available content ads for these languages and the user's country. It identifies the top 20 similar content items already present in the container and checks each for available content ads.

Suppose the first surrogate content is a popular action movie. The system finds a content ad for a new action movie with a similarity score above the identified threshold (e.g., 0.7). It then verifies that the content ad's campaign, content, and device impression caps have not been exceeded and that the ad is not already in the container or disliked by the user. If all conditions are met, the content ad is placed in the container with the promotional lever set, indicating it was promoted by the content promoter service 150.

### Data Services

FIG. 1C shows a collection of data services 190, in accordance with one or more embodiments. As shown in FIG. 1D, the data services 190 include a media repository 191, an advertising repository 192, an analytics repository 193, a user data repository 194, a machine learning (ML) repository 195, and a metadata repository 196. Various components of the data services 190 can be located on the same device (e.g., a server, mainframe, virtual server in a cloud environment, and any other device) or can be located on separate devices connected by a network (e.g., a local area network (LAN), the Internet, a virtual private cloud, etc.). Those skilled in the art will appreciate that there can be more than one of each separate component/service running on a device, as well as any combination of these components/services within a given embodiment.

In one or more embodiments of the invention, each repository (191, 192, 193, 194, 195, 196) of data services 190 includes both business logic and/or storage functionality. For purposes of this disclosure, the terms “repository” and “store” may refer to a storage system, database, database management system (DBMS), or other storage related technology, including persistent or non-persistent data stores, in accordance with various embodiments of the invention.

In one or more embodiments of the invention, each repository includes both persistent and non-persistent storage systems, as well as application logic configured to enable performant storage, retrieval, and transformation of data to enable the functionality described herein. Non-persistent storage such as Redis, Memcached, and an in-memory data store can be utilized to cache data in order to increase performance of frequently accessed data and reduce the latency of requests.

In one or more embodiments of the invention, the media repository 191 includes functionality to store media items. Media items can include both source media items, advertising media items, and derived media items such as previews or clips, and can comprise media types and file formats of various types. Examples of media items can include, but are not limited to, movies, television shows, series, episodes, video episodes, podcasts, music, audiobooks, documentaries, concerts, live event recordings, news broadcasts, educational content, instructional videos, sports events, video blogs (vlogs), reality shows, animations, short films, trailers, behind-the-scenes footage, interviews, and user-generated content. Each of these media items can be stored, categorized, and retrieved in multiple formats such as MP4, AVI, WMV, MOV, MP3, WAV, FLAC, and others.

In one or more embodiments of the invention, the advertising repository 192 includes functionality to store advertising content. The advertising content may optionally correspond to a source media item in the media repository 191. Advertising content within the repository can include various formats such as traditional commercial spots, interactive ads, sponsored content, banner ads, product placements, preroll and midroll video segments, overlay advertisements, branded graphics, and native advertising. These advertising formats can encompass a range of file types including, but not limited to, MPEG, MP4, AVI, MOV, GIF, PNG, JPEG, and HTML5 packages. The advertising repository 192 is engineered to categorize and manage these items based on metadata such as target demographics, content relevance, viewer preferences, engagement metrics, and advertising campaign parameters. In one or more embodiments of the invention, this enables the advertising service 140 to perform precise ad placement, ensuring that advertising content is appropriately matched to viewer profiles and media content types, thereby optimizing the advertising efficacy and viewer experience.

In one or more embodiments of the invention, the analytics repository 193 includes functionality to facilitate the functionality of the platform 100 by storing and organizing a wide array of analytics data relevant to serving, recommending, and promoting media content. For example, the analytics repository 193 may be configured to store metadata produced during the audio analysis phase and/or the video analysis phase. The types of data stored in the analytics repository 193 can include, but are not limited to, user interaction data, content performance metrics, viewing patterns, demographic information, and sentiment analysis results. In one or more embodiments of the invention, this repository may serve not only as a structured store of data but also as a reference database that the content promoter service 150 utilize to perform content promotion and related functions.

In one or more embodiments of the invention, the user data repository 194 includes functionality to store user data. User data may include, but is not limited to, user preferences for genres, viewing history, and content ratings, which can inform features such as content promotion/recommendation, discovery, search and relevance, and other elements of the system that may benefit or be dependent upon promotion of media items by the content promoter service 150. In one example, the repository stores user-specific content interaction history and viewing patterns. Subsequently, the content promoter service 150 leverages this information to tailor content recommendations and promotions when fulfilling content requests for that user, thus enhancing the media experience.

The data stored within this repository may range from simple user identifiers and associated media preferences to more complex behavioral patterns, such as viewing duration, user interactions with content, and frequency of media consumption. This data, which may be stored in formats such as JSON, XML, or relational databases, can also be utilized by the content promoter service 150 to refine its algorithms and enhance its accuracy in content promotion. By leveraging this detailed user data, the system can better tailor recommendations and minimize the likelihood of a poor user experience.

In one or more embodiments of the invention, the machine learning repository 195 is configured to function as a storehouse for machine learning models and associated datasets pertinent to the operation of the content promoter service 150 and related services. This repository 195 includes functionality to retain and manage a diverse array of data types and structures used for training, validating, and deploying machine learning models that enhance media analysis capabilities. The repository 195 may be configured to store datasets comprising preprocessed training data, feature sets, labeled datasets, model parameters, and evaluation metrics. These datasets may serve as training material for supervised learning models such as convolutional neural networks, recurrent neural networks, and more.

In one or more embodiments of the invention, in support of the content promoter service 150 objectives, the machine learning repository 195 facilitates functions such as storing preprocessed and annotated media files used for model training, where each file is associated with metadata describing media content. The machine learning repository 195 may be configured to store a variety of machine learning and related data, including but not limited to, model parameters, hyperparameters, and architecture configurations, logging performance metrics of models on validation sets to enable evaluation and comparison between different model iterations, and deployment packages that encapsulate trained models and inference code, ready to be deployed into the production environment.

In accordance with one or more embodiments of the invention, metadata repository 196 includes functionality to catalog, store, and facilitate access to a range of metadata. For example, the repository 196 may be configured to store JSON-formatted metadata outcomes from the media analysis process. The metadata may encompass a spectrum of media attributes including, but not limited to, title, genre, duration, language, production crew details, and content ratings.

### Content Promoter Service (Continued)

In one or more embodiments of the invention, the content promoter service 150 includes functionality to record and analyze performance metrics of the content item. Performance metrics can include user engagement data such as click-through rates, watch time, user ratings, and conversion rates. By analyzing these metrics, the service can make informed decisions about the future availability of the content item for artificial promotion. For example, if an unvetted content item consistently shows high engagement metrics, the service may decide to increase its availability or extend its promotion duration.

The content promoter service 150 can detect when the impression budget of the content item is exceeded after providing a set of vetted content items that includes the injected unvetted content item in response to a request. In response to this detection, the service 150 removes the availability of the content item for artificial promotion by the content cold-start service and/or other integrated services. For example, if the impression budget is set at 10,000 impressions and this limit is reached, the service will cease further promotion of the content item.

Similarly, the content promoter service 150 detects when the pacing parameter of a promoted content item is exceeded after the set of vetted content items, including the promoted content item, is provided in response to a request. Upon detection, the service pauses the availability of the promoted content item for artificial promotion until the pacing parameter is satisfied. For example, if the pacing parameter is 1,000 impressions per hour and this limit is exceeded, the service pauses promotion until the start of the next hour. Once the pacing parameter is satisfied, the content promoter service 150 resumes the availability of the promoted content item for artificial promotion. This ensures that the content item continues to receive controlled exposure, optimizing user engagement while adhering to the predefined promotion constraints. The pacing parameter can be defined as a number of impressions per time period, a function depicting a more granular threshold, or any other mechanism for defining a time-based threshold for serving the content item.

The content promoter service 150 can also detect when an unvetted content item has accumulated a threshold quantity of performance data after being injected into a set of vetted content items provided in response to a request. Upon reaching this threshold, the service designates the unvetted content item as a newly vetted content item. For instance, if an unvetted content item garners sufficient user engagement metrics over a predefined period, it is reclassified, allowing the content recommender service 160 to organically recommend it.

### Content Recommender Service

In one or more embodiments of the invention, the content recommender service 160 includes functionality to receive content requests for content for one or more containers, such as user interface components in end-user applications executing on client devices. Upon receiving such requests, the service identifies a set of vetted content items based on their historical performance. This involves analyzing past user interactions, engagement metrics, and other relevant data to select content items that are likely to be well-received by users. For example, content items with high watch times and positive user ratings are prioritized.

The content recommender service 160 can artificially promote unvetted content items by injecting them into the set of vetted content items and providing the combined set in response to content requests. This ensures that new or lesser-known content items receive visibility and opportunities for user engagement. For example, an unvetted content item may be placed alongside popular vetted items in a recommendation list, increasing its chances of being selected by users.

### Cold-Start Service

In one or more embodiments of the invention, the content cold-start service 155 includes functionality to select content items for promotion based on their similarity to surrogate content items within the set of vetted content items. This selection process leverages machine learning models to analyze various attributes of the content items and determine which new or unvetted items are likely to perform well based on their similarity to successful content items. For instance, a new movie might be promoted if it shares similar themes, genres, or production values with a highly rated existing movie.

### Machine Learning

Promotion parameters can also be inferred by a machine learning model executed by the model serving engine 153. The model serving engine 153 generates a set of feature vectors based on media metadata of the unvetted content item, which can include details such as the producer, director, actors, production budget, genre, and target audience. The machine learning model uses these feature vectors to predict optimal promotion parameters, ensuring a balanced approach to exposure and engagement. For instance, the model might predict an impression budget of 20,000 views, a pacing parameter of 2,000 views per day, and an ideal promotion timeframe during weekday evenings.

In one or more embodiments of the invention, the content promoter service 150 includes a user interface (UI) for administrators to configure/manage promotions and to view, modify, approve, or deny recommended promotion parameters. The UI allows setting parameters within predefined constraints and ensures compliance with regional policies. Debugging tools and logs are provided to track content ad history and diagnose issues with promotion performance.

The administrator can use the console application to initiate, pause, or end one or more campaigns for promoting a content item in the platform. The console application also includes functionality to display performance metrics of the campaign to the administrator and to display alerts for campaigns that have exceeded one or more predefined performance thresholds. The content promoter service 150 includes functionality to monitor campaign performance and trigger these alerts when a threshold is exceeded.

The promoter model serving engine 153 includes functionality to generate feature vectors based on media metadata of unvetted content items, financial budget allocations, availability timeframes, and other data associated directly or indirectly with the content. The media metadata can include details such as the producer, director, actors, and production budget of the content item. These feature vectors are inputs for machine learning models used to predict promotion parameters.

The promoter model serving engine 153 executes a supervised machine learning model using these feature vectors to infer promotion parameters such as impression budgets and pacing values for unvetted content items. For instance, the model might predict an optimal impression budget of 15,000 views and a pacing parameter that ensures the content item is promoted steadily over a week.

In one or more embodiments of the invention, the promoter model training module 154 includes functionality to train the supervised machine learning model using training data and validation data. This data comprises historical performance metrics, financial budget allocations, availability timeframes, and selected promotion parameters. The training process ensures that the model accurately predicts promotion parameters for new content items.

The promoter model training module 154 includes functionality to validate the supervised machine learning model by comparing its predictions with actual performance metrics of a validation set of content items. This validation step involves calculating accuracy metrics such as precision, recall, and/or mean squared error to ensure that the models meet predefined accuracy thresholds. Once validated, the promoter model training module 154 deploys the supervised machine learning model for use by the promoter model serving engine 153. This deployment occurs when the model meets the predefined accuracy thresholds, ensuring that only reliable models are utilized for predicting promotion parameters.

### Source vs Derivative Content

In one or more embodiments of the invention, the content platform 100 includes functionality to differentiate the performance of a content item from its derivative content, such as distinguishing between a movie and its trailer. As an example, the user engagement metrics and promotional strategies for a full-length movie differ significantly from those for a short trailer. The content promoter service 150 includes functionality to leverage metadata analysis and user interaction data to separately track and analyze the performance metrics of the primary content and its derivative content. For instance, a movie's performance may be evaluated based on metrics such as total watch time, user ratings, and completion rates, while its trailer might be assessed using metrics like view counts, click-through rates, and shareability.

In one or more embodiments of the invention, each content item, along with its derivative content, is assigned unique identifiers and associated metadata. This allows the content promoter service 150 to independently monitor the promotional impact and user engagement for both the primary content and its derivatives. By doing so, the system ensures that promotional strategies can be optimized for each type of content. For example, if a trailer garners significant user interest, the system can infer a potential high interest in the movie itself and adjust the promotion parameters accordingly, such as increasing the impression budget or prioritizing the movie in recommendation lists.

In one or more embodiments of the invention, the model serving engine 153 employs a machine learning model to analyze patterns in user interactions with both primary and derivative content. This analysis helps in predicting the optimal promotion parameters tailored to each content type. For example, if data shows that trailers typically perform well in short bursts shortly after release, the model can dynamically adjust the pacing and timing of trailer promotions to maximize impact. Conversely, for the movie itself, the model may focus on sustained promotion over a longer period to encourage full-length views.

In one example, extending the source content versus derived content discussion, the derived content includes advertisements for the source content items. In this case, source content refers to the main content that has already been analyzed and learned from, such as movies or episodes, which are stored and managed by the media repository 191. Derived content, in this context, refers to advertisements for these source content items, and are categorized as ad content. Ad content consists of new content for which there is little existing knowledge or performance data (i.e., unvetted content).

In one or more embodiments of the invention, the performance and analytics engine 152 within the content promoter service 150 tracks and analyzes user interactions with both source and derived ad content. This promotion allows the model serving engine 153 to learn from these new titles by generating feature vectors based on the gathered data, thereby enabling the content recommender service 160 to understand how best to recommend these new titles and their associated ads. This extension of the source versus derived content framework ensures that the platform 100 can effectively manage and promote new ad content to improve recommendation accuracy for both the advertisement and the source content item.

In one or more embodiments of the invention, the content promoter service 150 includes functionality to leverage cross-promotional strategies by correlating the performance data of derivative content with the primary content. If a trailer is particularly successful among a certain demographic or geographic region, the service 150 can target the movie promotion to similar audiences, thereby enhancing the efficiency of the promotional campaigns. This functionality may improve the accuracy of performance tracking and promotion strategies and enhance the overall user experience by delivering content that aligns more closely with user preferences and engagement patterns.

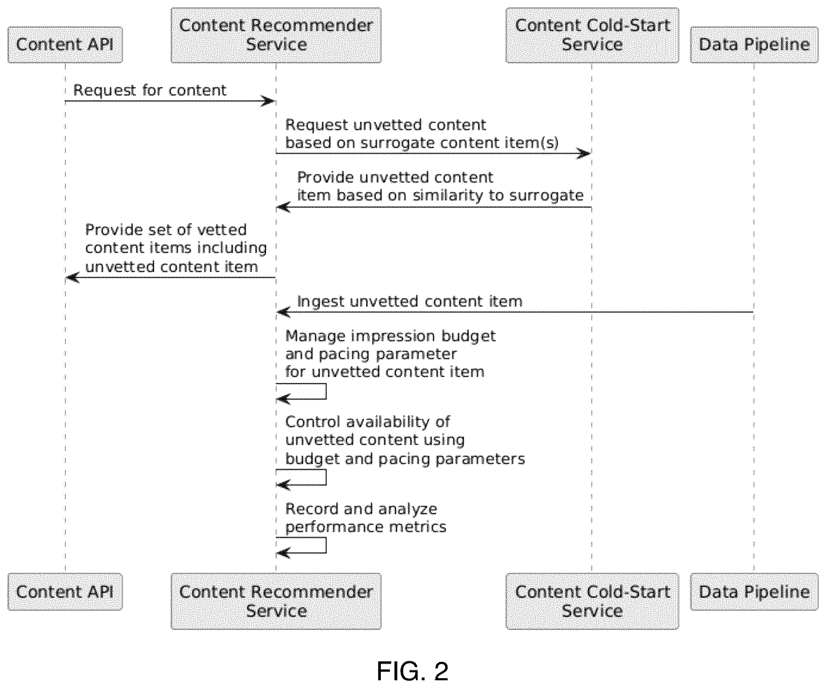

FIG. 2 shows an interaction diagram depicting a process of promoting content items using various components of the content platform 100, in accordance with one or more embodiments of the invention. The interaction involves the content API 170, content recommender service 150/160, content cold-start service 155, and data pipeline 140. For purposes of this example, the content promoter service 150 is a component of the content recommender service 150/160, and the functionality of the system will be described accordingly. The following description provides an explanation of the interactions between these components.

Initially, the content API 170 sends a request for content to the content recommender service 150/160. The content recommender service 150/160 identifies vetted content items and selects at least a subset of the vetted content items as surrogates for unvetted content. The recommender service 150/160 requests unvetted content based on the identified surrogate content items from the content cold-start service 155. The content cold-start service 155 processes this request by identifying unvetted content items that are similar to the surrogate content items. Once identified, the content cold-start service 155 provides the unvetted content item back to the content recommender service 150/160.

The content recommender service 150/160 then compiles a final result set incorporating the unvetted content item provided by the content cold-start service 155 alongside the surrogate content items. This combined set of content items is sent back to the content API 170 for further processing or presentation to the end user.

Separately, the data pipeline 140 ingests unvetted content items into the content recommender service 150/160. Within the content recommender service 150/160, several key functions are performed to manage and optimize the promotion of unvetted content items. The content recommender service 150/160 manages the impression budget and pacing parameters associated with the unvetted content item. It controls the availability of the unvetted content item using the established budget and pacing parameters, ensuring that the content is promoted in a balanced manner. The content recommender service 150/160 also records and analyzes performance metrics of the unvetted content item. This ongoing analysis helps refine promotion strategies and optimize the visibility and engagement of the content item.

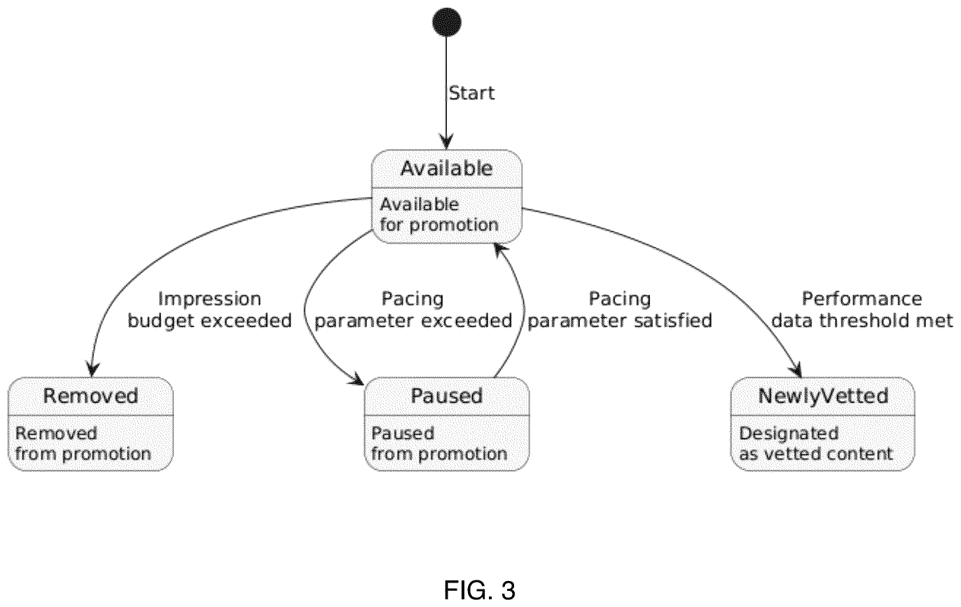

FIG. 3 shows a state diagram depicting state transitions for unvetted content within the content promoter service 150, in accordance with one or more embodiments of the invention. This diagram illustrates how unvetted content items transition between various states based on specific conditions and performance metrics.

The state diagram begins at the “Start” state, which represents the initial entry point for unvetted content into the promotion process. Upon entering the system, the unvetted content item moves to the “Available” state, indicating that it is available for promotion. While in this state, the content item can be promoted based on the predefined promotion parameters such as impression budget and pacing.

From the “Available” state, the unvetted content item can transition to several other states based on the following conditions:

Removed State: If the impression budget for the unvetted content item is exceeded, the content item transitions to the “Removed” state. In this state, the content item is removed from further promotion, ensuring that it does not exceed the allocated budget for impressions.

Paused State: If the pacing parameter for the unvetted content item is exceeded, the content item transitions to the “Paused” state. While in the “Paused” state, the content item is temporarily halted from promotion. This state ensures that the content item does not receive too many impressions in a short period, preventing overexposure. Once the pacing parameter is satisfied, the content item can transition back to the “Available” state, resuming promotion.

Newly Vetted State: If the unvetted content item accumulates sufficient performance data and meets a predefined performance data threshold, it transitions to the “Newly Vetted” state. In this state, the content item is designated as vetted content, indicating that it has garnered enough user engagement and metrics to be recommended organically by the content recommender service 160.

The transitions between these states are managed and controlled by the content promoter service 150, which includes functionalities for monitoring impression budgets, pacing parameters, and performance metrics. By dynamically managing these state transitions, the content promoter service 150 ensures that unvetted content items are promoted while adhering to the specified promotion constraints.

### Flowcharts

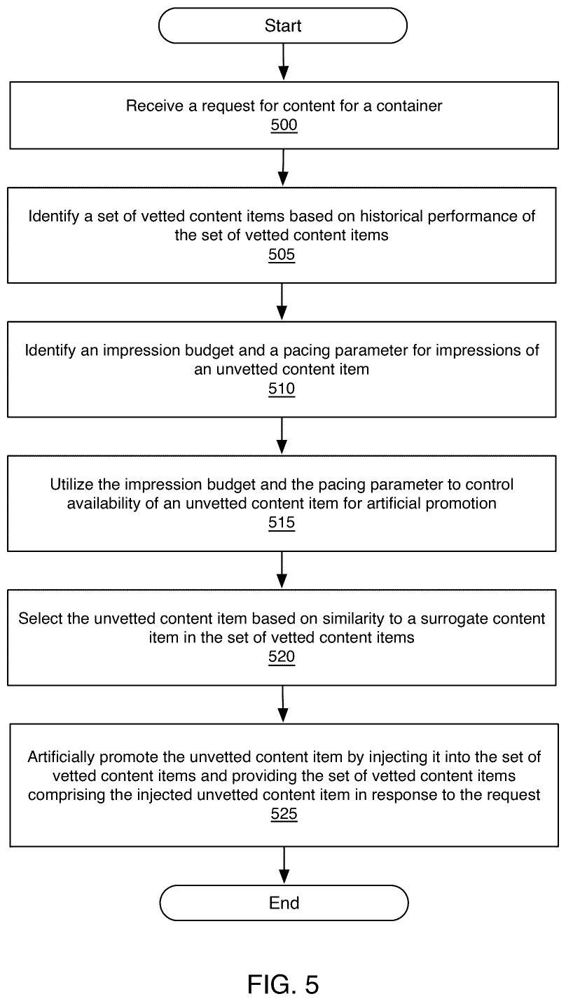

FIG. 5 shows a flowchart of a process for promoting content for a container. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 5 should not be construed as limiting the scope of the invention.

In STEP 500, a request is received for content for a container. This initial step involves identifying the need for content to fill a particular user interface component or container, which could be based on user activity or system scheduling.

In STEP 505, a set of vetted content items is identified based on the historical performance of the set of vetted content items. This step involves analyzing past user interactions, engagement metrics, and other relevant data to select content items that are likely to be well-received by users.

In STEP 510, an impression budget and a pacing parameter for impressions of an unvetted content item are identified. These parameters are used for managing the visibility and exposure of new content items, ensuring they are promoted in a controlled and effective manner.

In STEP 515, the impression budget and the pacing parameter are utilized to control the availability of an unvetted content item for artificial promotion. This step involves dynamically adjusting the promotion of the content item to adhere to the set budget and pacing constraints.

In STEP 520, the unvetted content item is selected based on similarity to a surrogate content item in the set of vetted content items. This selection leverages machine learning models to identify new content that shares attributes with existing content.

In STEP 525, the unvetted content item is artificially promoted by injecting it into the set of vetted content items and providing the set of vetted content items comprising the injected unvetted content item in response to the request. This final step ensures that the new content item gains visibility alongside established content, enabling it to accumulate performance data in order to eventually become recommended organically.

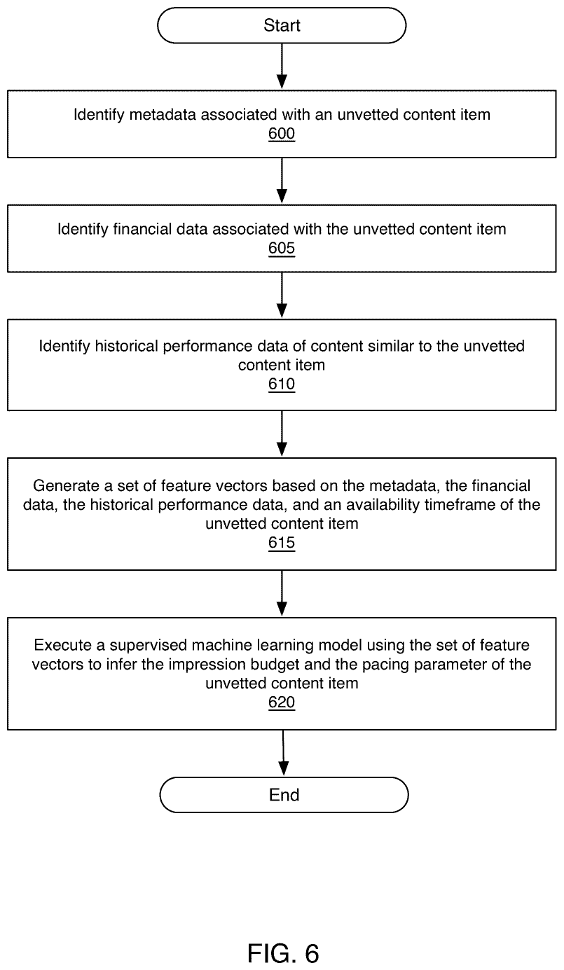

FIG. 6 shows a flowchart of a process for inferring promotion parameters for an unvetted content item using a supervised machine learning model. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 6 should not be construed as limiting the scope of the invention.

In STEP 600, metadata associated with an unvetted content item is identified. This metadata can include details such as the title, genre, director, cast, production details, and other relevant attributes that describe the content item.

In STEP 605, financial data associated with the unvetted content item is identified. This financial data can include information such as the production budget, marketing budget, and other cost-related details associated with the content item.

In STEP 610, historical performance data of content similar to the unvetted content item is identified. This involves analyzing past performance metrics of similar content items to understand how they have performed in terms of user engagement, viewership, and other relevant factors.

In STEP 615, a set of feature vectors is generated based on the metadata, the financial data, the historical performance data, and an availability timeframe of the unvetted content item. These feature vectors serve as inputs for the machine learning model, capturing all relevant information needed to predict promotion parameters.

In STEP 620, a supervised machine learning model is executed using the set of feature vectors to infer the impression budget and the pacing parameter of the unvetted content item. The machine learning model analyzes the input data to predict optimal values for these parameters as an effective promotion strategy for the new content item.

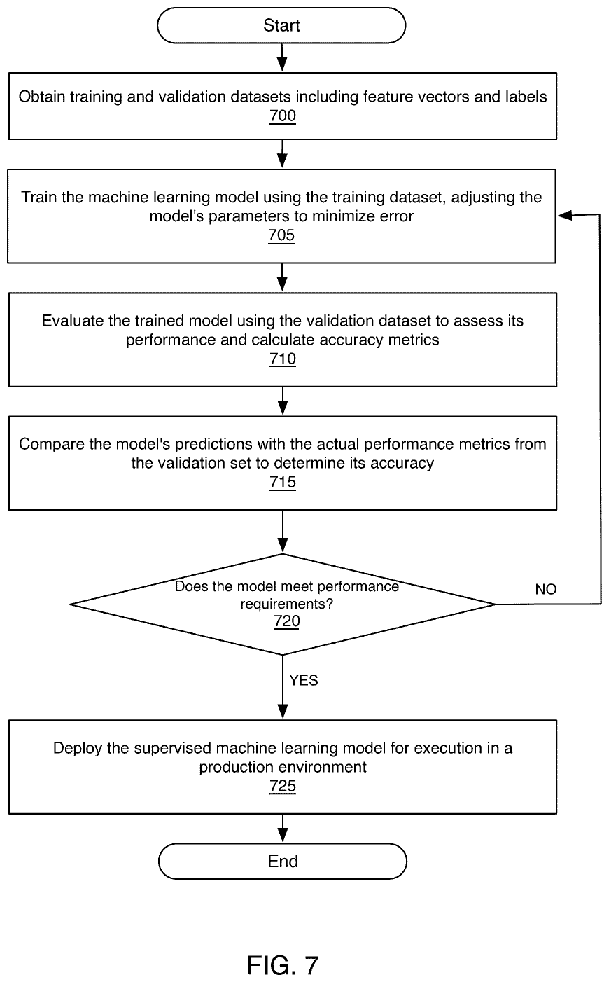

FIG. 7 shows a flowchart of a process for training, validating, and deploying a supervised machine learning model for inferring promotion parameters of content items. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 7 should not be construed as limiting the scope of the invention.

In STEP 700, training and validation datasets, including feature vectors and labels, are obtained. These datasets comprise historical data and performance metrics necessary for training and validating the machine learning model.

In STEP 705, the machine learning model is trained using the training dataset, adjusting the model's parameters to minimize error. This step involves using algorithms to optimize the model based on the training data to improve its predictive accuracy.

In STEP 710, the trained model is evaluated using the validation dataset to assess its performance and calculate accuracy metrics. This evaluation helps determine how well the model generalizes to new, unseen data by comparing its predictions with the validation dataset.

In STEP 715, the model's predictions are compared with the actual performance metrics from the validation set to determine its accuracy. This step involves calculating various accuracy metrics, such as precision, recall, and mean squared error, to quantify the model's performance.

In STEP 720, it is determined whether the model meets performance requirements. If the model does not meet the specified requirements, the process loops back to STEP 705 for further training and adjustment. If the model meets the performance requirements, the process proceeds to the next step.

In STEP 725, the supervised machine learning model is deployed for execution in a production environment. This final step involves integrating the trained and validated model into the live system, where it can be used to infer promotion parameters for content items based on real-time data.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

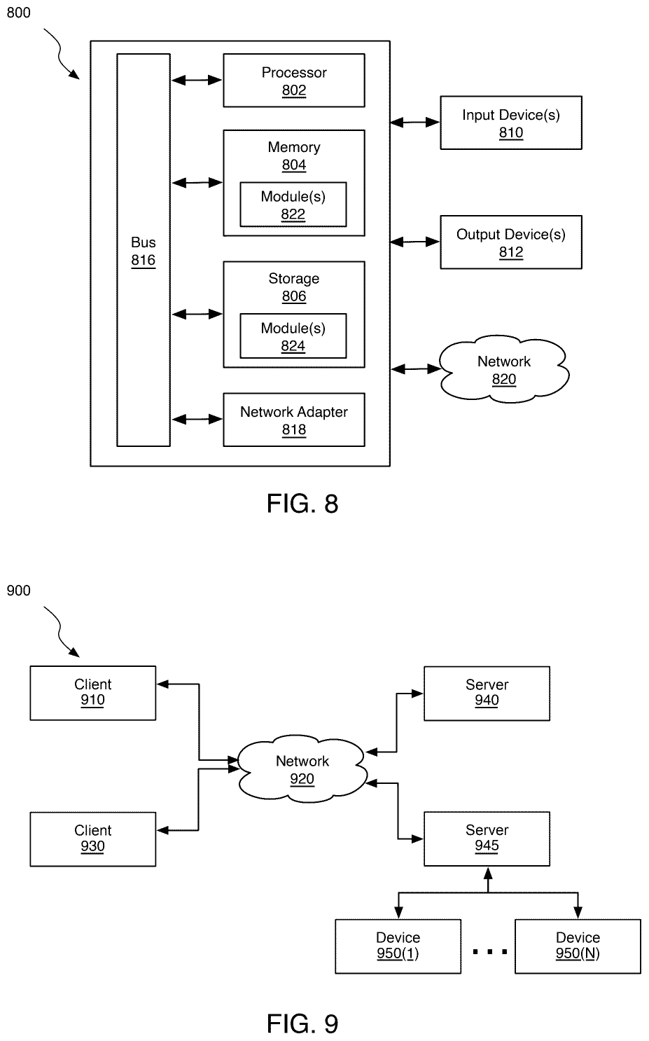

For example, as shown in FIG. 8, the computing system 800 may include one or more computer processor(s) 802, associated memory 804 (e.g., random access memory (RAM), cache memory, flash memory, etc.), one or more storage device(s) 806 (e.g., a hard disk, an optical drive such as a compact disk (CD) drive or digital versatile disk (DVD) drive, a flash memory stick, etc.), a bus 816, and numerous other elements and functionalities. The computer processor(s) 802 may be an integrated circuit for processing instructions. For example, the computer processor(s) may be one or more cores or micro-cores of a processor.

In one or more embodiments, the computer processor(s) 802 may be an integrated circuit for processing instructions. For example, the computer processor(s) 802 may be one or more cores or micro-cores of a processor. The computer processor(s) 802 can implement/execute software modules stored by computing system 800, such as module(s) 822 stored in memory 804 or module(s) 824 stored in storage 806. For example, one or more of the modules described herein can be stored in memory 804 or storage 806, where they can be accessed and processed by the computer processor 802. In one or more embodiments, the computer processor(s) 802 can be a special-purpose processor where software instructions are incorporated into the actual processor design.

The computing system 800 may also include one or more input device(s) 810, such as a touchscreen, keyboard, mouse, microphone, touchpad, electronic pen, or any other type of input device. Further, the computing system 800 may include one or more output device(s) 812, such as a screen (e.g., a liquid crystal display (LCD), a plasma display, touchscreen, or other display device), a printer, external storage, or any other output device. The computing system 800 may be connected to a network 820 (e.g., a local area network (LAN), a wide area network (WAN) such as the Internet, mobile network, or any other type of network) via a network interface connection 818. The input and output device(s) may be locally or remotely connected (e.g., via the network 820) to the computer processor(s) 802, memory 804, and storage device(s) 806.

One or more elements of the aforementioned computing system 800 may be located at a remote location and connected to the other elements over a network 820. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

FIG. 9 is a block diagram of an example of a network architecture 900 in which client systems 910 and 930, and servers 940 and 945, may be coupled to a network 920. Network 920 may be the same as or similar to network 920. Client systems 910 and 930 generally represent any type or form of computing device or system, such as client devices (e.g., portable computers, smart phones, tablets, smart TVs, etc.).

Similarly, servers 940 and 945 generally represent computing devices or systems, such as application servers or database servers, configured to provide various database services and/or run certain software applications. Network 920 generally represents any telecommunication or computer network including, for example, an intranet, a wide area network (WAN), a local area network (LAN), a personal area network (PAN), or the Internet.

With reference to computing system 900 of FIG. 9, a communication interface, such as network adapter 918, may be used to provide connectivity between each client system 910 and 930, and network 920. Client systems 910 and 930 may be able to access information on server 940 or 945 using, for example, a Web browser, thin client application, or other client software. Such software may allow client systems 910 and 930 to access data hosted by server 940, server 945, or storage devices 950(1)-(N). Although FIG. 9 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 940, server 945, storage devices 950(1)-(N), or any combination thereof. All or a portion of one or more of the example embodiments disclosed herein may also be encoded as a computer program, stored in server 940, run by server 945, and distributed to client systems 910 and 930 over network 920.

Although components of one or more systems disclosed herein may be depicted as being directly communicatively coupled to one another, this is not necessarily the case. For example, one or more of the components may be communicatively coupled via a distributed computing system, a cloud computing system, or a networked computer system communicating via the Internet.

And although only one computer system may be depicted herein, it should be appreciated that this one computer system may represent many computer systems, arranged in a central or distributed fashion. For example, such computer systems may be organized as a central cloud and/or may be distributed geographically or logically to edges of a system such as a content/data delivery network or other arrangement. It is understood that virtually any number of intermediary networking devices, such as switches, routers, servers, etc., may be used to facilitate communication.

One or more elements of the aforementioned computing system 900 may be located at a remote location and connected to the other elements over a network 920. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

One or more elements of the above-described systems (e.g., FIGS. 1A-1D) may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems (e.g., FIGS. 1A-1C) and/or flowcharts (e.g., FIGS. 4-7). Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

1. A system for promoting content items in a content platform, comprising:
a computer processor;
a promoter model serving engine comprising functionality to:
generate a set of feature vectors based on a set of media metadata of an unvetted content item, a financial budget allocation of the unvetted content item, and an availability timeframe of the unvetted content item; and
execute a supervised machine learning model using the set of feature vectors to infer an impression budget and a pacing parameter of the unvetted content item; and
a content promoter service executing on the computer processor and comprising functionality to:
utilize the impression budget and the pacing parameter to control availability of the unvetted content item for artificial promotion by a content cold-start service;
a content recommender service comprising functionality to:
receive a request for content for a container;
identify a set of vetted content items based on historical performance of the set of vetted content items;
artificially promote the unvetted content item by injecting it into the set of vetted content items and providing the set of vetted content items comprising the injected unvetted content item in response to the request;
the content cold-start service configured to select the unvetted content item based on similarity to a surrogate content item in the set of vetted content items.

2. The system of claim 1, wherein the content promoter service further comprises functionality to:
record and analyze at least one performance metric of the unvetted content item to control future availability of the unvetted content item for artificial promotion by the content cold-start service.

3. The system of claim 1, wherein the content promoter service further comprises functionality to:
after the set of vetted content items comprising the injected unvetted content item is provided in response to the request, detect that the impression budget of the unvetted content item is exceeded; and
in response to the impression budget being exceeded, remove availability of the unvetted content item for artificial promotion by the content cold-start service.

4. The system of claim 1, wherein the content promoter service further comprises functionality to:
after the set of vetted content items comprising the injected unvetted content item is provided in response to the request, detect that the pacing parameter of the unvetted content item is exceeded;
in response to the pacing parameter being exceeded, pause availability of the unvetted content item for artificial promotion by the content cold-start service until the pacing parameter is satisfied; and
resume availability of the unvetted content item for artificial promotion by the content cold-start service in response to the pacing parameter being satisfied.

5. The system of claim 1:
wherein the content promoter service further comprises functionality to:
after the set of vetted content items comprising the injected unvetted content item is provided in response to the request, detect that the unvetted content item has accumulated more than a threshold quantity of performance data;
designate the unvetted content item as a newly vetted content item in response to the unvetted content item having accumulated more than the threshold quantity of performance data; and
wherein the content recommender service further comprises functionality to organically recommend the newly vetted content item.

6. (canceled)

7. The system of claim 1, wherein the set of media metadata comprises a producer of the unvetted content item, a director of the unvetted content item, at least one actor of the unvetted content item, and a media production budget of the unvetted content item.

8. The system of claim 1, further comprising:
a promoter model training engine comprising functionality to:
train the supervised machine learning model using training data and validation data that comprises historical performance data of content items, financial budget allocations, and availability timeframes;
validate the supervised machine learning model by comparing its predictions with actual performance metrics of a validation set of content items;
calculate at least one accuracy metric selected from a group consisting of precision, recall, and mean squared error, to ensure the supervised machine learning model's predictions meet a predefined accuracy threshold; and
deploy the supervised machine learning model for use by the promoter model serving engine in response to the at least one accuracy metric meeting the predefined accuracy threshold.

9. A method for promoting content items in a content platform, comprising:
receiving a request for content for a container;
generating a set of feature vectors based on a set of media metadata of an unvetted content item, a financial budget allocation of the unvetted content item, and an availability timeframe of the unvetted content item;
executing a supervised machine learning model using the set of feature vectors to infer an impression budget and a pacing parameter of the unvetted content item;
identifying a set of vetted content items based on historical performance of the set of vetted content items;
utilizing, by a computer processor, the impression budget and the pacing parameter to control availability of an unvetted content item for artificial promotion;
selecting the unvetted content item based on similarity to a surrogate content item in the set of vetted content items; and
artificially promoting the unvetted content item by injecting it into the set of vetted content items and providing the set of vetted content items comprising the injected unvetted content item in response to the request.

10. The method of claim 9, further comprising:
recording and analyzing at least one performance metric of the unvetted content item to control future availability of the unvetted content item for artificial promotion.

11. The method of claim 9, further comprising:
after the set of vetted content items comprising the injected unvetted content item is provided in response to the request, detecting that the impression budget of the unvetted content item is exceeded; and
in response to the impression budget being exceeded, removing availability of the unvetted content item for artificial promotion.

12. The method of claim 9, further comprising:
after the set of vetted content items comprising the injected unvetted content item is provided in response to the request, detecting that the pacing parameter of the unvetted content item is exceeded;
in response to the pacing parameter being exceeded, pausing availability of the unvetted content item for artificial promotion until the pacing parameter is satisfied; and
resuming availability of the unvetted content item for artificial promotion in response to the pacing parameter being satisfied.

13. The method of claim 9, further comprising:
after the set of vetted content items comprising the injected unvetted content item is provided in response to the request, detecting that the unvetted content item has accumulated more than a threshold quantity of performance data;
designating the unvetted content item as a newly vetted content item in response to the unvetted content item having accumulated more than the threshold quantity of performance data; and
organically recommending the newly vetted content item.

14. (canceled)

15. The method of claim 9, wherein the set of media metadata comprises a producer of the unvetted content item, a director of the unvetted content item, at least one actor of the unvetted content item, and a media production budget of the unvetted content item.

16. The method of claim 9, further comprising:
training the supervised machine learning model using training data and validation data that comprises historical performance data of content items, financial budget allocations, and availability timeframes;
validating the supervised machine learning model by comparing its predictions with actual performance metrics of a validation set of content items;
calculating at least one accuracy metric selected from a group consisting of precision, recall, and mean squared error, to ensure the supervised machine learning model's predictions meet a predefined accuracy threshold; and
deploying the supervised machine learning model in response to the at least one accuracy metric meeting the predefined accuracy threshold.

17. A non-transitory computer-readable storage medium comprising a plurality of instructions for promoting content items in a content platform, the plurality of instructions configured to execute on at least one computer processor to enable the at least one computer processor to:
receive a request for content for a container;
generate a set of feature vectors based on a set of media metadata of an unvetted content item, a financial budget allocation of the unvetted content item, and an availability timeframe of the unvetted content item, wherein the set of feature vectors are used by a supervised machine learning model to infer an impression budget and a pacing parameter of the unvetted content item;
identify a set of vetted content items based on historical performance of the set of vetted content items;
utilize the impression budget and the pacing parameter to control availability of an unvetted content item for artificial promotion;
select the unvetted content item based on similarity to a surrogate content item in the set of vetted content items; and
artificially promote the unvetted content item by injecting it into the set of vetted content items and providing the set of vetted content items comprising the injected unvetted content item in response to the request.

18. The non-transitory computer-readable storage medium of claim 17, wherein the plurality of instructions are further configured to enable the at least one computer processor to:
record and analyze at least one performance metric of the unvetted content item to control future availability of the unvetted content item for artificial promotion.

19. The non-transitory computer-readable storage medium of claim 17, wherein the plurality of instructions are further configured to enable the at least one computer processor to:
after the set of vetted content items comprising the injected unvetted content item is provided in response to the request, detect that the impression budget of the unvetted content item is exceeded; and
in response to the impression budget being exceeded, remove availability of the unvetted content item for artificial promotion.

20. The non-transitory computer-readable storage medium of claim 17, wherein the plurality of instructions are further configured to enable the at least one computer processor to:
after the set of vetted content items comprising the injected unvetted content item is provided in response to the request, detect that the pacing parameter of the unvetted content item is exceeded;
in response to the pacing parameter being exceeded, pause availability of the unvetted content item for artificial promotion until the pacing parameter is satisfied; and
resume availability of the unvetted content item for artificial promotion in response to the pacing parameter being satisfied.
